(19) United States
(12) Patent Application Publication
(10) Pub. No.: US 2002/0161914 A1
(43) Pub. Date: Oct. 31, 2002

(54) Method and arrangement for congestion control in packet networks

(75) Inventor: Stanislav Belenki, Goteborg (SE)

Correspondence Address: HOWREY SIMON ARNOLD & WHITE LLP, 1299 PENNSYLVANIA AVE., NW, BOX 34, WASHINGTON, DC, 20004, US

(73) Assignee: Chalmers Technology Licensing AB, Goteborg (SE)

(21) Appl. No.: 10/063,483

(22) Filed: Apr. 29, 2002

Related U.S. Application Data
(63) Continuation of application No. PCT/SE00/02129, filed on Oct. 30, 2000.
(60) Provisional application No. 60/198,639, filed on Apr. 20, 2000.

(30) Foreign Application Priority Data
Oct. 29, 1999 (SE) 9903981-0
Dec. 3, 1999 (SE) 9904430-7
Apr. 20, 2002 (SE) 0001497-7

(51) Int. Cl. G06F 15/16

(52) U.S. Cl. 709/235; 709/233

(57) ABSTRACT

The present invention refers to a method and arrangement for controlling congestion of a network node capacity shares used by a set of data flows in a communications network, especially a tagged communications network having links and nodes. The data flows include non-terminated data flows having specific characteristics. The network has different states of functionality, wherein in a first state when congestion or congestion anticipation in the specific characteristics substantially within the node of the network occurs, admission of new data flows having the specific characteristics is disabled, a number of flows are selected and a service level of the selected flows is changed. The arrangement mainly includes a classifier arrangement, a load meter, first and second lists, first, second and third selectors a queue arrangement and scheduler.

### CROSS REFERENCE TO RELATED APPLICATIONS

The present application is a continuation of International Application No. PCT/SE00/02129, filed Oct. 30, 2000 and published in English pursuant to PCT Article 21(2), now abandoned, and which claims priority to Swedish Application Nos. 9903981-0, filed Oct. 29, 1999, 9904430-7, filed Dec. 3, 1999, and 0001497-7, filed Apr. 20, 2000, and United States Provisional Application No. 60/198,639, filed Apr. 20, 2000, now abandoned. The disclosures of all applications are expressly incorporated herein by reference in their entirety.

### BACKGROUND OF INVENTION

1. Technical Field

The present invention relates to a method and arrangement in communications network. More specifically, the invention relates to a method of controlling congestion in a network node's capacity shares used by a set of data flows in a communications network, especially a tagged communications network comprising links and nodes, the data flows including non-terminated data flows having specific characteristics.

2. Background Information

In telecommunication applications demanding certain level of transmission quality, e.g., some maximum data loss and transmission delay, it is vital to ensure that there are enough resources to support the quality. In the old analog telephone systems this problem was availability of a vacant wire to allocate for a new user. In today's packet-switched networks the same issue considers whether there is enough link and buffer capacity to place a new connection.

Today's networks are more complicated than the analog telephone systems, at least in part because different connections appear to exhibit different activity patterns. Thus, while a particular set of resources seems appropriate for one connection it is insufficient for another. This has led to forcing every connection to signal its characteristics, e.g., peak rate, average rate and maximum burst size to the communication nodes (switches or routers) over which it intends to reach the destination.

Equipped with this data, network nodes make a decision to accept a connection or not. There are two major ways the decision, or the connection admission control (CAC), can be carried out either based on the worst case parameters of the already established connections, or according to the measured usage parameters of the node where the decision is being taken. The first approach is the most conservative and ensures there is no loss of data (i.e., packets) in the established connections. However, this conservative approach comes at the expense of low utilization of the network resources. This is because the connections occur in bursts and therefore do not generate packets at a constant rate throughout their life time. Rather, they submit packets in bursts, with the maximum possible packet rate of each train equal to the peak rate of the connection.

The other approach for making a decision as whether to accept a connection is based on the measured usage parameters attempts to utilize the bursty property of the traffic in order to achieve a statistical gain. This gain is achieved due to some connections being inactive while others generate some packets. The approach produces higher utilization of the network resources than the worst-case allocation methods by trying to estimate the equivalent bandwidth. (The equivalent bandwidth is the minimum bandwidth that is needed to satisfy transmission quality of the admitted connections.) Thus, when there are many connections on the same link, the equivalent bandwidth is less than the peak rate—allocated bandwidth due to the statistical gain.

In order to calculate the exact value of the estimate bandwidth, it is necessary to know the exact stochastic characteristics of the admitted connections. However, this is impractical to achieve; therefore, some estimate of the equivalent bandwidth has to be used. The estimate can be achieved by measuring usage of resources of a particular network node. In this case, a network node making the admission decision uses some online measure of availability of its resources, e.g., buffer level and/or link utilization, some performance target parameters (such as maximum delay or packet loss rate) and the traffic descriptor of the new connection to find out if the targets will be violated in case the new connection is admitted. The simplest implementation of this approach is to use the sum of a window-based measure of the buffer occupancy or link utilization and the respective characteristics of the new flow (the maximum burst size divided by the link rate and the peak rate). If any of the sums is greater than the respective target the flow is rejected. This and other measurement-based approaches are analyzed in Comments on the Performance of Measurement-Based Admission Control Algorithms, by L. Breslau, et al., Proceedings of INFOCOM 2000, vol. 3, pp. 1233-42.

Any measurement-based CAC (“MBCAC”) risks violating the target performance level. This is because the measurement process always contain an error due to variability of the traffic activity. Thus, a resource usage measurement that is obtained before a new connection arrives can be too low compared to the theoretical equivalent bandwidth due to low traffic activity in that measurement interval. In general, it is possible to adjust parameters of the measurement process to compensate for the error by making the estimate of the equivalent bandwidth more or less conservative. It is hard to set parameters responsible for the conservatism of any particular MBCAC because the traffic behavior is difficult to predict a-priory. A wrongly set level of the conservatism can result either into violation of the performance targets or under-utilization of the resources.

A number of methods have been developed which propose tuning of the MBCAC's conservatism through value of some parameter of the method to reach the target performance. In particular, Zukerman et al. in An Adaptive Connection Admission Control Scheme for ATM Networks, Proceedings of ICATM 1997, Vol. 3, pp. 1153-57, suggests controlling the conservatism via the length of the “warming up” period. During this warming up period, a newly admitted connection is assumed to generate traffic at its peak rate. The method uses a Cell Loss Rate predictor (the paper was written in context of ATM) to identify probability of violation of the target loss rate. The predictor uses past history of the observed traffic, peak rate of the candidate connection and the assumption that flows that are in the warming up period transmitting at their peak rates. Thus, a longer warming up period increases conservatism of the admission decision and vice versa.

Another method described by Zukerman et al. in A Measurement Based Admission Control for ATM Networks, Proceedings of ICATM 1998, pp. 140-44, in addition to adjusting the warming up period, introduces an “Adaptive Weight Factor”. The factor is used to weight contribution of available bandwidth calculated according to the peak rates of the existing connections and available bandwidth as it is measured online. When the factor increases the portion of the peak rate-calculated bandwidth decreases making the admission decision less conservative, and the other way around.

Shimoto et al. in A Simple Multi-QoSA TM Buffer Management Scheme Based on Adaptive Admission Control, Proceedings of CLOBECOM 1996, Vol. 1, pp. 447-51, suggest adjusting the conservatism by varying length of a time period over which the minimum equivalent bandwidth observed in the previous period is used to make the admission decision. The longer the interval, the more conservative the admission decision.

In Measurement-Based Adaptive Call Admission Control in Heterogeneous Traffic Environment with Virtual Switches and Neural Networks, Proceedings of APCC/OECC 1999, Vol. 1, pp. 171-74, Yeo et al. propose to use two neural networks, NN1 and NN2. NN1 is fed the observed offered load and produces an estimation of the equivalent bandwidth (the minimum capacity to satisfy the target performance). The equivalent bandwidth estimates are saved in a table together with such information as the number of connections in different traffic classes for which a particular estimate is valid. NN2 makes the admission decisions based on the equivalent bandwidth estimates from the table. The conservatism adjustment is done by using different training patterns for the neural networks.

Another MBCAC that uses an adaptive scheme for controlling the conservatism is shown in Bao et al., Performance-driven Adaptive Admission Control for Multimedia Applications, Proceedings of ICC 1999, Vol. 1, pp. 199-203. There the authors use a MBCAC from Jamin et al., A Measurement-Based Admission Control Algorithm for Integrated Service Packet Networks, IEEE/ACM Transactions on Networking, Vol. 5, no. 1, pp. 56-70, Feb. 1997, which employs two measurement intervals, T and S, measured in the number of observed packets such that T=nS (n is some integer). Every S packets the method produces a measure of the observed performance (bandwidth and buffer utilization). After T packets have been observed, the method selects the maximum value of the performance measurements obtained over all n S-packet intervals. The selected measurement is used in the next T interval as the amount of used resources to calculate their availability for a candidate flow. The adaptation is achieved by altering between the maximum and the average performance values observed over the S-packet intervals. If only the maximum values are used, the admission decisions are the most conservative. Thus, when there is a threat of violation of the target loss rate the resulting adaptive MBCAC resorts to the use of maximum values of the performance measures within the S-packet intervals.

All the methods described above always favor connections with smaller traffic parameters, e.g. peak rate, as compared with bigger traffic parameter connections (see, Jamin et al.). Thus, e.g., voice calls of the same priority but using different voice compression may get unfair rejection rate among each other.

Also, the methods described above demand some description (at least the peak rate) of the candidate flows to make the admission decisions. Unfortunately, the ability of a new connection to signal its traffic parameters is implemented only in the IntServ framework (see, Braden et al. RFC 1633 Integrated Services in the Internet Architecture: an Overview, Available by ftp to ftp.ietf.org/rfc/). And the IntServ has been found suffering from salability problems (see, Detti et al. Supporting RSVP in a Differentiated Service Domain: an Architectural Framework and a Salability Analysis, Proceedings of ICC 1999, Vol. 1, pp. 204-10). That is why the Differential Service (DS) has been chosen as the most viable approach towards the future networking. DS, however, has a disadvantage of allowing the connections to communicate an approximate level of the transmission quality they want to receive while no traffic description can be signaled.

Next, the DS framework is described in brief and an example of congestion mishandling in a DS network is presented.

The Differential Service (“DS”), see for example, “An Architecture for Differential Service”, RFC 2475, is a definition of a set of rules that allow a computer network to provide a differential transmission service to packet flows with different tolerance to delay, throughput, and loss of the packets. The DS defines a set of network traffic types through the use of certain fields in the IP (Internet Protocol) datagram header. Particular values of the fields are denoted DS Code Points (“DSCP”). Each of the DSCP corresponds to a Per Hop Behavior, or PHB. A PHB identifies how the DS handles a packet in respective DSCP network nodes. PHBs range from the best effort transfer to the leased line emulation.

The major advantage of the DS is that it relies on policing and shaping of the packet flows on the so-called boundary nodes. The boundary nodes as defined by the DS are those network nodes which connect the end nodes, or other networks, to a DS network. The DS also defines the interior nodes, which connect boundary nodes to each other and to other interior nodes. Thus, the interior nodes constitute the core of a DS network, an example of which is illustrated in FIG. 1. The network comprises the End Nodes (EN) 10A-10D, Boundary Nodes (BN) 11A-11D, Interior Nodes (IN) 12A-12E and 13A-13l. The paths that a data packet can travel between two end nodes, e.g., between 10A and 10B or 10D and 10C are illustrated with lines 14A and 14B, respectively.

Because the number of flows passing through an IN 12A-12E is much higher at a given time period, the node must have relatively powerful processing units and/or memory resources to police and form all these flows in case the functions were not performed by the BNs 11A-11D. The burden of the functions is considered heavy enough by the network building society to turn down use of such protocols like RSVP and ATM, which rely on the functions on the all nodes of the networks (although ATM is widely used for its flexible bandwidth management).

The BNs 11A-11D are also responsible for authorizing the packet flows for being served by the network. Because the DS does not define any Connection Admission Control (CAC) within a DS network, every flow that is accepted and policed by a BN is considered eligible for the transfer service which corresponds to the flow's DSCP. Thus, there has to be an A-priority provision of network resources within every DS node according to the anticipated number of flows of each of the DSCPs. Because, the dynamic of the flows is assumed to be high, the DS defines an exchange of statistics on current resource consumption by different flows among key nodes of a DS network, so the latter, and in particular the boundary nodes, could balance resource allocation between flows of different types. The DS, however, does not define any particular scheme for collecting and distributing the statistics, as well as it does not define any actions that should be taken by a node upon receiving statistics from another node. The DS definition, although, mentions that collection, distribution and actions related to the statistics are supposed to be complex. Such networks where packets are tagged according to a certain principle (quality of transmission in case of the DS framework) are also called tag networks.

As it is, the DS framework is posed against a dilemma of keeping little or no network traffic flow state at the network nodes in order to avoid complexity of RSVP and ATM, while providing a guaranteed quality of the transmission service to the packet flows. However, the partial state of the packet flows defined in the DS through the DSCP does not allow fulfilling the guarantees. Each DSCP defines a capacity pipe (also a tag pipe) within a physical link between all physically connected DS nodes, which is dedicated to all flows with that particular DSCP, while DS nodes are not capable to distinguish individual flows within such a pipe. Thus, if the flow starts using a previously uncontested pipe, which leads to a congestion, then the node servicing the pipe would have to start discarding packets from all the flows filling the pipe, including the new one. This is not fair with respect to the other flows, and such protocols like RSVP and ATM would not allow the new flow to be installed at the channel. Thus, the DS framework does not allow keeping the guarantees to the flows that demand them. This case is exemplified in FIG. 1, where a flow 14A from node 10A to node 10B starts transmission when a flow MB from end node 10C to end node 10D has already been transmitting for a certain time period. Both flows have the same DSCP value. In the figure, it is assumed that the pipe corresponding to this DSCP served by node 12B gets congested due to the new flow from node 10A to node 10B.

U.S. Pat. No. 5,835,484 to Yamato et al. (“the ′484 patent”) suggests a scheme for controlling congestion in the communication network, capable of realizing a recovery from the congestion state by the operation at the lower layer level for the communication data transfer alone, without relying on the upper layer protocol to be defined at the terminals. In a communication network including first and second node systems, a flow of communication data transmitted from the first node system to the second node system is monitored and regulated by using a monitoring parameter. On the other hand, an occurrence of congestion in the second node system is detected according to communication data transmitted from the second node system, and the monitoring parameter used in monitoring and regulating the flow of communication data is changed according to a detection of the occurrence of congestion in the second node system.

U.S. Pat. No. 5,793,747 to Kline (“the ′747 patent”) relates to a method for scheduling transmission times for a plurality of packets on an outgoing link for a communication network. The method comprises the steps of: queuing, by a memory controller, the packets in a plurality of per connection data queues in at least one packet memory, wherein each queue has a queue ID; notifying, by the memory controller, at least one multi-service category scheduler, where a data queue is empty immediately prior to the memory controller queuing the packets, that a first arrival has occurred; calculating, by a calculation unit of the multi-service category scheduler, using service category and present state information associated with a connection stored in a per connection context memory, an earliest transmission time, TIME EARLIEST and an updated PRIORITY INDEX and updating and storing present state information in a per connection context memory; generating, by the calculation unit, a “task” inserting the task into one of at least a first calendar queue; storing, by the calendar queue, at the calculated TIME EARLIEST, the task in one of a plurality of priority task queues; removing, by a priority task decoder, at a time equal to or greater than TIME EARLIEST in accordance with a time opportunity, the task from the priority task queue and generating a request to the memory controller; dequeueing the packet by the memory controller and transmitting the packet; notifying, by the memory controller, where more packets remain to be transmitted, the multi-service category scheduler that the per connection queue is unempty; calculating, by the calculation unit, an updated TIME EARLIEST and an updated PRIORITY INDEX based on service category and present state information associated with the connection, and updating and storing present state information in the per connection context memory; generating, where the per connection queue is unempty, a new task using the updated TIME EARLIEST, by the calculation unit, for the connection and returning to step E, and otherwise, where the per connection queue is empty, waiting for the notification by the memory controller and returning to step C.

The object of the invention is to solve the difficulty that arises because WRR (Weighted Round Robin) is a polling mechanism that requires multiple polls to find a queue that requires service. Since each poll requires a fixed amount of work, it becomes impossible to poll at a rate that accommodates an increased number of connections. In particular, when many connections from bursty data sources are idle for extended periods of time, many negative polls may be required before a queue is found that requires service. Thus, there is a need for an event-driven cell scheduler for supporting multiple service categories in an asynchronous transfer mode ATM network.

According to U.S. Pat. No. 5,777,984 to Gun, et al. (“the ′984 patent”), a need exists for a robust method of determining congestion in a cell based network. In particular, and in the context of ATM networks, there is a need for a method and apparatus for first determining congestion, and then reducing the cell transmission rates being sourced on the ATM network. In a cell based network, the invention includes transmission paths, which each include at least one switch and at least one transmission link coupled to the at least one switch, each switch and transmission link having limited cell transmission resources and being susceptible to congestion, a method of controlling a user source transmission rate to reduce congestion.

It is an object of U.S. Pat. No. 5,703,870 to Murase (“the ′870 patent”) to prevent congestion of one network from causing congestion of another network and to prevent the influence of external traffic from causing congestion of a network which receives the external traffic. A congestion control method for a system having a first network representing a subset of a switching network constituted by a set of switching nodes connected to each other and a second network which serves as a subset of the switching network and does not have a switching node common to the first network. The method includes the steps of: classifying traffic into first traffic (x) starting and finishing in the first network, second traffic (y) directed from the first network to the second network, third traffic (z) directed from the second network to the first network, and fourth traffic (w) which does not correspond to any one of the first traffic, the second traffic, and the third traffic; and upon occurrence of congestion in the first network, selectively controlling those classified traffics to reduce said congestion and/or the influence thereof on the second network.

International Publication No. WO 97/43869 relates to a method of managing a common buffer resource shared by a plurality of processes including a first process, the method including the steps of: establishing a first buffer utilization threshold for the first process; monitoring the usage of the common buffer by the plurality of processes; and dynamically adjusting the first buffer utilization threshold according to the usage.

This and similar problems arise from the fact that DS network nodes do not perform any admission control, because in DS framework it is impossible to identify traffic parameters of a candidate flow which are necessary for the admission decision.

The inability of the DS to identify individual connections can be resolved with help of the Multi Protocol Label Switching (MPLS) (see, IETF MPLS working group at http://www.ietf.org/html.charters/mpls-charter.html). MPLS is allows the connections to establish a label at every hop from the source to the destination to avoid the routing table lookups on every packet. Each node uses the labels to automatically identify the output port for the incoming packet. Thus, arrival of a new connections can be identified by the fact that a new label has been established.

Thus, the problem of CAC in this setup can be formulated as: a CAC which is unaware of the connections' traffic descriptors but knows arrivals of the new connections and the capacity pipe target performance parameters.

### SUMMARY OF INVENTION

The present invention provides a method and arrangement that overcome those problems related to known techniques in a simple and effective way. This is accomplished by reducing or eliminating problems related to congestion.

Thus, implementation of the invention can provide fair distribution of the congestion impact among the flows in terms of the oldest flows not being responsible for the congestion, as well as regulating admission rate of the new flows to avoid future congestion and keeping performance of the network nodes at a target level.

The present invention further provides an improved method for managing the over-subscription of a common communications resource shared by a large number of traffic flows, such as ATM connections. The present invention also provides an efficient method of buffer management at the connection level of a cell switching data communication network so as to minimize the occurrence of resource overflow conditions.

Moreover, none of above mentioned documents suggest an arrangement according to the invention, ie., keeping identities of N the most recently arrived flows in DS network nodes for some or all DSCP pipes, and if a newly arrived flow causes congestion or a congestion anticipation at the node serving the pipe, the node changes service level of the flow so that the flow is isolated from the older flows. If the congestion persists, the node changes service level of the flow, which arrived before the last one. The procedure continues until the congestion is eliminated. While in congestion, the node changes service levels of all the new flows. Furthermore, according to the invention a stable state of operation of the capacity pipe given the target performance parameters such as target link and/or buffer utilization and/or loss rate by enforcing a flow admission rate is achieved.

Further, the invention achieves a stable state of operation of the capacity pipe given the target performance parameters such as target link and/or buffer utilization and/or loss rate by enforcing a flow admission rate. The idea behind enforcing the flow admission rate is that any network node comprising input ports connected to a buffer and an output port serving the buffer can maintain a certain number of flows with particular stochastic characteristics with given target performance parameters. For example, the higher the loss rate target, the higher the number of flows the node can serve. Thus, to keep the network node or capacity pipe within the target performance parameters under heavy load, it is necessary to maintain the number of flows present in the system around some constant value given that their stochastic characteristics are stationary. If flows are capable of explicitly signaling their termination, the invention performs the following: whenever a flow served by the pipe or node terminates, a new flow is allowed to be admitted. This is similar to the approach that uses a fixed number to control the number of flows present in the node or pipe. However, the fixed number has to be predefined according to the assumed traffic parameters or by a guess. It is widely accepted that a-priory traffic parameterization is difficult, while the guess method can lead either to under-utilization or violation of the performance parameter targets. However, the invention identifies the optimal number of flows the node or pipe can serve by sensing violation of the performance parameter targets in an active or a proactive way. Thus, when there is a threat that the targets will be violated or they are actually violated, the invention either removes some flows to eliminate the congestion or congestion threat and then activates a counter which is incremented when a flow terminates and reduced when a new flow is admitted. If a new flow arrives to the counter when the latter is zero it is either rejected or is placed in a waiting line to be admitted when the counter becomes nonzero.

If the flows are not able to explicitly signal their termination two approaches can be used to regulate the admission rate in the described manner. The first one is to use a time out on flow activity, that is, if the node or pipe does not observe packets of a particular flow over a certain time interval the flow is considered to be terminated. This approach, however, has scalability problem since the node or the pipe has to monitor activity of all the flows it is serving. The other approach proposed by the invention is to perform an adaptive estimate of the average flow inter-termination delay. In this case when there is no congestion the method uses either zero or a nonvalue of the enforced flow inter-arrival delay achieved during the previous congestion. In case of a congestion, i.e., violation of the target performance parameter values and zero delay value the method uses some initial value, e.g., double of measured average flow inter-arrival delay. Otherwise, if the delay value is non-zero the method increases the delay value since the previous value resulted in too admission of too many flows. At the same time the method optionally isolates a number of flows that are considered to be admitted in violation of the target performance parameter values to allow for quicker elimination of the congestion. If the utilization of the node or the pipe becomes lower than that indicated by the target values the method reduces value of the enforced inter-arrival delay to avoid under-utilization of the node or capacity pipe. The method can employ some minimum value for the delay to avoid too radical reduction of the delay value. The minimum value can be obtained as, e.g., the value of the delay when the performance parameter targets are violated.

In analogy with the case of the explicit signaling of the termination the enforced flow inter-arrival delay is used to control value of the counter which, in its turn, controls admission of new flows and restoration of the removed (isolated) flows. In particular, the counter is incremented whenever the number of seconds equal the enforced delay value has elapsed since the last counter increment. The counter is reduced by one if it is non-zero and a new flow arrives or there is a previously isolated flow waiting to be restored.

Therefore the initially mentioned method for the network having different states of functionality, includes a first step when congestion or congestion anticipation occurs, whereby the enforced average flow inter-arrival delay is increased by using the real flow inter-termination rate (reciprocal of the respective delay) or the estimated optimal flow inter-arrival rate (reciprocal of the respective delay) and a number of flows are selected and the service level of the selected flows is changed.

Therefore the initially mentioned method is characterized in that the initially mentioned network has different states of functionality. In a first state when congestion or congestion anticipation in said specific characteristics substantially within the node of said network occurs, admission of new data flows having said specific characteristics is disabled, a number of flows are selected and a service level of the selected flows is changed and/or an enforced average flow inter-arrival delay is changed. The capacity share is associated with a packet servicing priority level and/or a packet flow aggregation criterion. Preferably, the specific characteristics include one or several of same priority or service level, being part of the same capacity share and flow aggregate. More specifically, the specific characteristics are not based on a time, the packets of the flows have spent in upstream nodes and/or on count of said upstream nodes the packets have passed through before the node that detects the congestion.

Preferably, a number of flow identities are selected from a first list either at random or of the youngest flows whose specific characteristic includes a service level is unchanged. Most preferably, a number of data flows whose packets are in a queue, while a link is congested, are selected and their identities are saved in a second list. The selection is from head and/or tail and/or middle of a the queue and/or through a selection principle.

The above mentioned specific characteristic including a service level of the youngest flows is changed first.

In a second state, there is no congestion, and new flows are allowed on the link. Preferably, a number of most recent flows are remembered in the first list or a number of elected flows are remembered in said first list. The identities of the data flows that have terminated are removed from the lists.

In a third state, the load of the specific characteristic including priority level is between the congestion or congestion anticipation threshold and the new flow admission threshold; no new flows with the priority level are allowed on the link.

In fourth state, the load drops below the new flow admission threshold. Either a number of flow identities of the flows whose specific characteristic includes a service level has been changed are selected from a first list and/or a number of flow identities from a second list are selected and their service level is restored. The selection is made at random and/or in an order and/or with respect to the oldest flows. Moreover, no new flows are allowed on the link while there are flows with changed service level in the first list and/or the second list.

A transition condition from the second state to the first state exists if the load reaches and/or exceeds the congestion or congestion anticipation threshold. A transition condition from the first state to the third state exists if the load drops below the congestion or congestion anticipation threshold but stays above the new flow admission threshold. A transition condition from the third state to the first state exists if the load reaches and/or exceeds the congestion or congestion anticipation threshold. A transition condition from the third state to the second state exists if the load drops below the new flow admission threshold and there are no non-terminated flows with service level changed from the service level (priority level class). A transition condition from the third state to the fourth state exists if the load drops below the new flow admission threshold and there are non-terminated flows with changed service level. A transition condition from the third state to the first state exists if the load reaches and/or exceeds the congestion or congestion anticipation threshold. A transition condition from the third state to the second state exists if there are no flows with changed service level, i.e., they either terminated or their service level was restored.

Suitably, the load is measured by length of the queue and/or packet loss rate and/or the number of established flows. Preferably, the network is differential service network.

According to a second aspect of the invention, an arrangement for controlling congestion of a network node capacity shares used by a set of data flows in a communications network, especially a tagged communications network comprising links and nodes, the data flows including non-terminated data flows having specific characteristics. The arrangement mainly includes a classifier arrangement, a load meter, first and second lists, first, second and third selectors, a queue arrangement, and scheduler. The classifier arrangement is provided for classifying packets to the priority/capacity queues/pipes, eg., based on their header field values. The load meter is arranged to measure the load in terms of queue size and/or packet loss rate and/or the number of established flows and compares it against at least two thresholds, i.e., congestion or congestion anticipation and new flow admission.

In a first phase the first selector selects flow identities from the queue and saves them in the first list. In a second phase, the load meter detects congestion or congestion anticipation and starts the second and/or third selectors if they have not been started, no new flows are allowed on the queue/pipe, said second selector selects flow identities from the queue and saves them in a second list, said third selector selects flow identities from the lists and modifies said specific characteristic in form of service level of the respective flows, such that the flows are removed from the current priority level/pipe. In a third phase, after the queue load falls below a congestion/congestion anticipation level but not below a new flow admission level the load meter stops first and/or second selectors. In a fourth phase, the load meter detects the load of the queue being under the new flow admission threshold and instructs the third to restore service level of the service level modified flows in an ordered or random way. When all the service level modified flows have obtained their service level restored, admission of new flows on the queue is allowed. The modified service level of the respective flows is through altering classification criteria of the classifier arrangement. The third selector senses load of other priority levels/capacity pipes before moving the flows to the said levels/pipes. The third selector contains flow identities from previous congestion periods and can before taking flow identities from the first list and second list modify service level of said previously selected flows. The third selector can modify service level of said previously selected flows. The congestion threshold is equal to the new flow admission threshold.

In one embodiment, the enforced average flow inter-arrival delay is increased. The enforced average flow inter-arrival delay is increased by using a real flow inter-termination rate, which is reciprocal of the respective delay or the estimated optimal flow inter-arrival rate and a number of flows are selected and the service level of the selected flows is changed. However, the congestion and/or congestion anticipation is defined as zero value of a counter (CNT) with the value of the counter updated according to a scheme, conditioned that there has been a violation of Performance Parameter Targets (PPTs), the scheme comprising the steps of: setting the value of said counter to zero when the PPTs are violated; incrementing the counter when a predetermined time period Delay (DEL) has elapsed since the last increment or zeroing as according to the previous step; the counter is reduced when a new flow arrives or service level of a service-level-changed flow is restored and the counter is non-zero.

The value of variable DEL is updated according to the following scheme:

1. value of DEL is increased when the PPTs are violated;

2. if after step 1, PPTs are not violated value of DEL is reduced;

3. in step 1 the value of DEL is saved before it is increased in a second variable (MIN_DEL), which is used as the lowest margin for reducing value of DEL in step 2.

The congestion and/or congestion anticipation is defined by value of a timer (T) such that T<DEL or T≦DEL, where DEL is delay variable, conditioned there has been a violation of the PPTs, wherein the value of a timer is updated according to the following scheme: the timer is zeroed when the PPTs are violated; the timer is zeroed when its value is such that T>DEL or T≧DEL and a new flow arrives; the value of DEL is updated as before.

In one embodiment, the congestion and/or congestion anticipation is defined as zero value of counter (CNT) conditioned there has been a violation of PPTs whereby a value of CNT is defined in the following way: if there have not been violations of PPTs (Performance Parameter Targets) value of CNT is disregarded, any flow is allowed on the link, CNT is set to zero when there is a violation of PPTs, CNT is incremented when a flow terminates on the link, and CNT is reduced if a new flow arrives on the link and CNT is non-zero.

Preferably, the congestion and/or congestion anticipation is defined as zero value of a counter (CNT) conditioned that there has been a violation of the PPTs, whereby the value of the counter will be updated according to the following scheme: the counter is zeroed when the Performance Parameter Targets (PPT) are violated; the counter is incremented when DEL seconds have elapsed since the last increment or zeroing as according to the previous step; the counter is reduced when a new flow arrives or a service-level-changed flow is gets its service level restored and the counter is non-zero, value of variable DEL is set to the measured flow inter-termination delay.

The invention also concerns a medium readable by means of a computer and/or a computer data signal embodied in a carrier wave and having a computer readable program code embodied therein. The computer is at least partly being realized as an arrangement for controlling congestion of a network node capacity shares used by a set of data flows in a communications network. The data flows include non-terminated data flows having specific characteristics.

The arrangement mainly includes a classifier arrangement, a load meter, first and second lists, first, second and third selectors, a queue arrangement and a scheduler. The program code is provided for causing the arrangement to assume: a first phase in which the first selector selects flow identities from the queue and saves them in the first list; a second phase, in which the load meter detects congestion or congestion anticipation and starts the second and/or third selectors if they have not been started, no new flows are allowed on the queue/pipe, the second selector selects flow identities from the queue and saves them in a second list, the third selector selects flow identities from the lists and modifies the specific characteristic in form of service level of the respective flows, such that the flows are removed from the current priority level/pipe; a third phase, in which, after the queue load falls below a congestion/congestion anticipation level but not below a new flow admission level, the load meter stops first and/or second selectors; and a fourth phase, in which the load meter detects load of the queue being under the new flow admission threshold and instructs the third to restore service level of the service level modified flows in an ordered or random way.

### BRIEF DESCRIPTION OF DRAWINGS

In the following, the invention will be described in more detail in a non-limiting way with reference to the accompanying drawings, in which:

FIG. 1 is a schematic illustration of a communications network,

FIG. 2 is a state diagram for a network according to FIG. 1 and implementing the invention,

FIG. 3 is a time-load diagram,

FIG. 4 is a flowchart showing the steps of another particular method according to the invention,

FIG. 5 is a block diagram showing an arrangement for implementing an arrangement in accordance with a first embodiment of the invention,

FIG. 6 is a block diagram showing an arrangement for implementing an arrangement in accordance with a second embodiment of the invention,

FIGS. 7 and 8 are diagrams showing two different measurements on the follows, according to the invention, and

FIG. 9 is a state diagram illustrating main states of another embodiment according to the invention.

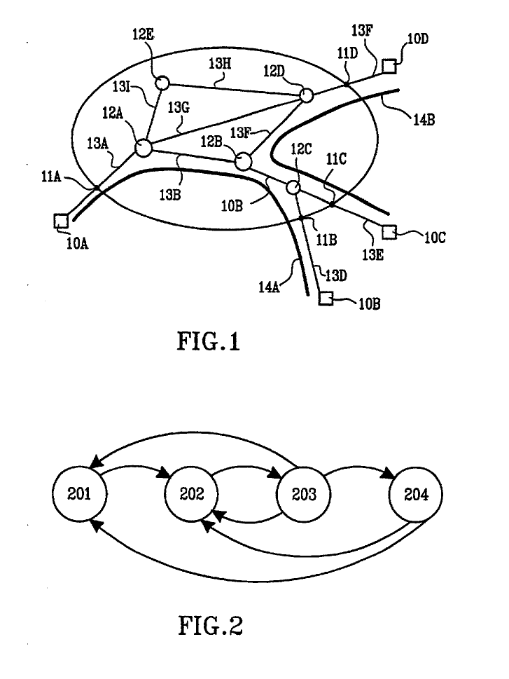

### DETAILED DESCRIPTION

The invention relates to controlling congestion impact on those flows present on a congested link or pipe, and localizing the congestion impact within a limited number of flows, assuming that each of the active flows does not consume more resources than its predefined capacity share. The load level that is needed to be reduced from the link or the pipe in order to eliminate the congestion limits the number of impacted flows.

According to a general aspect of the invention, illustrated in the flowchart of FIG. 2, the method for controlling the congestion links and link capacity shares of tagged networks can be considered as a state machine, having the following states:

201. No congestion: new flows are allowed on the link; N most recent flows are remembered in a first list L1 and/or M flows chosen at random or based on some other way optionally, identities of the flows that have terminated (present in all the states) are removed,

202. Congestion or congestion anticipation: admission of new flows in that capacity pipe is disabled; either a number of flows whose packets are in the queue [while the link is congested] (from head and/or tail and/or middle of the queue and/or by other selection principle) are selected and their IDs are saved in a second list L2; and/or a number of flow identities are selected from L1 (either at random or of the most youngest flows whose SL is unchanged); change service level of the selected flows (the youngest flows first).

203. The load between the congestion or congestion anticipation threshold and the new flow admission threshold: no new flows are allowed on the in that capacity pipe.

204. The load has crossed the new flow admission threshold either select (at random and/or in an order and/or the oldest ones) a number of flow IDs from list Li; and/or a number of flow IDs from list L2 are selected and their service level is restored; no new flows are allowed on the link.

The state transition conditions can be summarized by:

201 to 202: load (length of the queue) reaches and/or exceeds the congestion or congestion anticipation threshold;

202 to 203: load (length of the queue) after having exceeded the congestion or congestion anticipation threshold drops below the said threshold but stays above the new flow admission threshold;

203 to 202: load (length of the queue) reaches and/or exceeds the congestion or congestion anticipation threshold;

203 to 201: the load drops below the new flow admission threshold and there are no non-terminated flows with changed service level;

203 to 204: the load drops below the new flow admission threshold and there are non-terminated flows with changed service level;

204 to 202: load (length of the queue) reaches and/or exceeds the congestion or congestion anticipation threshold;

204 to 201: there are no flows with changed service level (they either terminated or their service level was restored).

The load is preferably measured in terms of queue size and/or packet loss rate and/or the number of established flows.

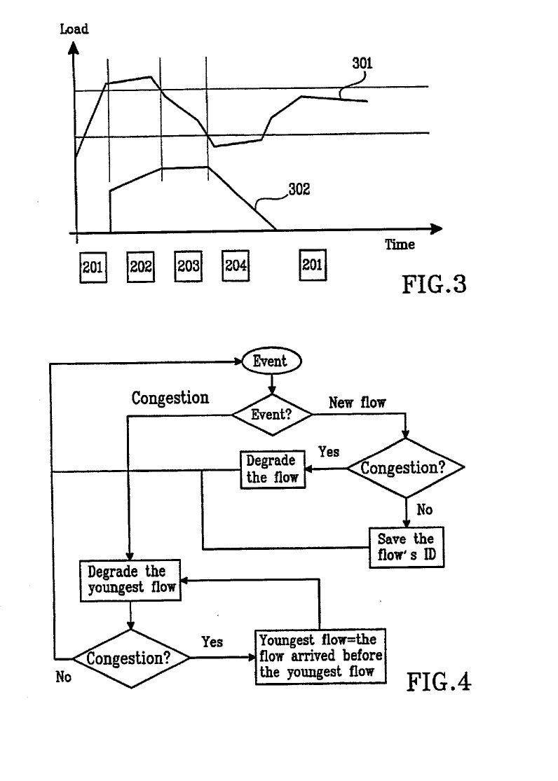

The diagram of FIG. 3 illustrates the load level for different states. Graph 301 presents the queue size (load) and the graph 302 is size (cardinal) of the SL-modified flows set.

In one particular embodiment of the invention, a flowchart of which is shown in FIG. 4, the method keeps IDs of N the most recently arrived flows in DS network nodes for some or all DSCP pipes. Such an ID must be sufficient to identify packets belonging to different flows within a pipe. If a newly arrived flow causes congestion or a congestion anticipation at the node serving the pipe, the node degrades service level of the flow so that the flow is isolated from the alder flows. If the congestion persists, the node degrades service level of the flow, which arrived before the last one. This continues until the congestion is eliminated. While in congestion, the node degrades service levels of all the new flows. Changing service level of a flow means either upgrading or degrading the service depending on the flow's identity, and/or the agreement between the network provider and the customer that generates the flow.

The pseudo-code of this implementation can be realized by:

initialize

flow ID={source address, source port, destination address, destination port, protocol number};

list=cycle buffer of N IDs;

pointer=0;

first flow pointer=address of the first element in the list;

last flow pointer=address of the first element in the list;

remove pointer=last flow pointer;

if (new flow)

if (the pipe is congested)

reassign the flow to a lower quality pipe or discard the flow;

send a notification to the source of the flow about the reassignment;

else

increase last flow pointer;

if (last flow pointer=first flow pointer)

load the new flow ID into the first flow pointer location;

first flow pointer++;

else

load the flow's ID into the pointed memory;

if (congestion)

while (congestion)

reassign flow pointed at by the last flow pointer to a lower quality pipe or discard the flow;

last flow pointer−−;

send a notification to the source of the flow about the reassignment;

N could be calculated based on the capacity demands of flows of a particular pipe if the demands are known a priory. If the pipe capacity, for example, is CP and each flow has a fixed bandwidth demand c, then N=CP/c+safety margin.

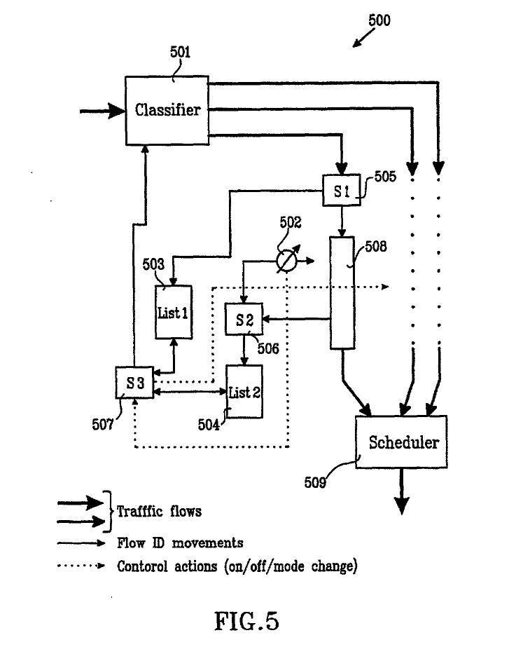

In another particular embodiment of the invention, a flowchart of which is shown in FIG. 5, the method keeps IDs of N the most recently arrived flows in DS network nodes for some or all DSCP pipes. Such an ID must be sufficient to identify packets belonging to different flows within a pipe. If a newly arrived flow causes congestion or congestion anticipation at the node serving the pipe, the node degrades service of the flow. If the congestion persists, the node degrades the flow which flow, which arrived before the last one. This continues until the congestion is eliminated. While in congestion, the node degrades all the new flows.

The method may also be realized with the following pseudo-code:

initialize

flow ID={source address, source port, destination address, destination port, protocol number};

list=cycle buffer of N IDs;

pointer=0;

first flow pointer=address of the first element in the list;

last flow pointer=address of the first element in the list;

remove pointer=last flow pointer;

if (new flow)

if (the pipe is congested)

reassign the flow to a lower quality pipe or discard the flow;

send a notification to the source of the flow about the reassignment;

else

increase last flow pointer;

(last flow pointer=first flow pointer)

load the new flow ID into the first flow pointer location;

first flow pointer++;

else

load the flow's ID into the pointed memory;

if (congestion)

while (congestion)

reassign flow pointed at by the last flow pointer to a lower quality pipe or discard the flow;

last flow pointer−−;

send a notification to the source of the flow about the reassignment;

N can be calculated based on the capacity demands of flows of a particular pipe/link if the demands are known a-priory. For example, if pipe capacity is CF and each flow has a fixed bandwidth demand c, then N=CP/c+safety margin.

The invention can be implemented both as a hardware application and/or software application in routing, mediating and switching arrangements of a communications network.

One non-limiting embodiment of an arrangement 500 for implementing the invention is illustrated in FIG. 5. The arrangement includes a filter or classifier arrangement 501, a load meter 502, first and second lists 503 and 504, first, second and third selectors 505-507, a queue arrangement 508 and scheduler 509. The classifier arrangement 501 is provided for classifying packets to the priority/capacity queues/pipes, e.g., based on their header field values. The load meter 502 measures load of a particular priority class/capacity pipe as the class' queue size and/or packet loss rate and/or the number of established flows and compares it against at least two thresholds, i.e. congestion or congestion anticipation and new flow admission. The lists and queue are realized as memory units. The scheduler 509 controls the different priority levels. Clearly, other parts needed for correct function of the arrangement can occur.

The following example simplifies the understanding of the function of the arrangement. In a first phase, the first selector S1 selects flow identities from the queue and saves them in the first list L1, 503.

In a second phase, the load meter 502 detects congestion or congestion anticipation and starts selectors S2 and/or S3 if they have not been started. No new flows are allowed on the queue/pipe. S2 selects flow identities from the queue 508 and saves them in a second L2. S3 selects flow identities from the lists 503 and 504 and modifies service level of the respective flows by altering filtering criteria of the filter arrangement, such that the flows are removed from the current queue. S3 can also sense load of other queues before moving the flows to the said queues. S3 can contain flow identities from previous congestion periods and can before taking flow identities from the first list and second list, can modify service level of the said previously selected flows. In a third phase, after the queue load falls below the congestion/congestion anticipation level but not below the new flow admission level the load meter stops S3 and/or S2. In a fourth phase, the load meter detects load of the queue being under the new flow admission threshold and instructs S3 to restore service level of the service level modified flows in an ordered or random way; when all the service level modified flows have obtained their service level modified admission of new flows on the queue is allowed.

The invention also includes a case where the node that detects congestion of a priority level/flow aggregate/capacity pipe sends control messages to upstream and/or downstream nodes of the flows that are selected to have their service level changed so that the upstream and/or downstream nodes change service level of the flows. In this case, the node that detects the congestion may also change service level of the flows.

In one preferred embodiment of the invention, a flow admission rate is enforced. The idea behind enforcing the flow admission rate is that any network node comprising input ports connected to a buffer and an output port serving the buffer can maintain a certain number of flows with particular stochastic characteristics with given target performance parameters. The higher the loss rate target, for example, the higher is the number of flows the node can serve. Thus, to keep the network node or capacity pipe within the target performance parameters under heavy load, it is necessary to maintain the number of flows present in the system around some constant value assuming that their stochastic characteristics are stationary. If flows are capable of explicitly signaling their termination, the invention performs the following: whenever a flow served by the pipe or node terminates, a new flow is allowed to be admitted. This is similar to the approach that uses a fixed number to control the number of flows present in the node or pipe. However, the fixed number has to be predefined according to the assumed traffic parameters or by a guess.

It is widely accepted that A-priory traffic parameterization is difficult, while the guess method can lead either to under-utilization or violation of the performance parameter targets. The invention, however, identifies the optimal number of flows the node or pipe can serve by sensing violation of the performance parameter targets in an active or a proactive way. Thus, when there is a threat that the targets will be violated or they are actually violated, the invention either removes some flows to eliminate the congestion or congestion threat and then activates a counter which is incremented when a flow terminates and reduced when a new flow is admitted. If a new flow arrives to the counter when the latter is zero it is either rejected or is placed in a waiting line to be admitted when the counter becomes non-zero.

If the flows are not able to explicitly signal their termination, two approaches can be used to regulate the admission rate in the described manner. The first one is to use a time out on flow activity. That is, if the node or pipe does not observe packets of a particular flow over a certain time interval, the flow is considered to be terminated. However, this approach has scalability problem since the node or the pipe has to monitor activity of all the flows it is serving. The other approach proposed by the invention is to perform an adaptive estimate of the average flow inter-termination delay. In this case when there is no congestion, the method uses either zero or a nonvalue of the enforced flow inter-arrival delay achieved during the previous congestion. In case of congestion, i.e., violation of the target performance parameter values, and zero delay value the method uses double of measured average flow inter-arrival delay. Otherwise, if the delay value is non-zero the method increases the delay value since the previous value resulted in too admission of too many flows. At the same time the method optionally isolates a number of flows that are considered to be admitted in violation of the target performance parameter values to allow for quicker elimination of the congestion. If the performance of the node or the pipe becomes lower than that indicated by the target values the method reduces value of the enforced inter-arrival delay to avoid under-utilization of the node or capacity pipe.

Analogous with the case of the explicit signaling of the termination, the enforced flow inter-arrival delay is used to control value of the counter which, in its turn, controls admission of new flows and restoration of the removed (isolated) flows. In particular, the counter is incremented whenever the number of seconds equal the enforced delay value has elapsed since the last counter increment. The counter is reduced by one if it is non-zero and a new flow arrives or there is a previously isolated flow waiting to be restored.

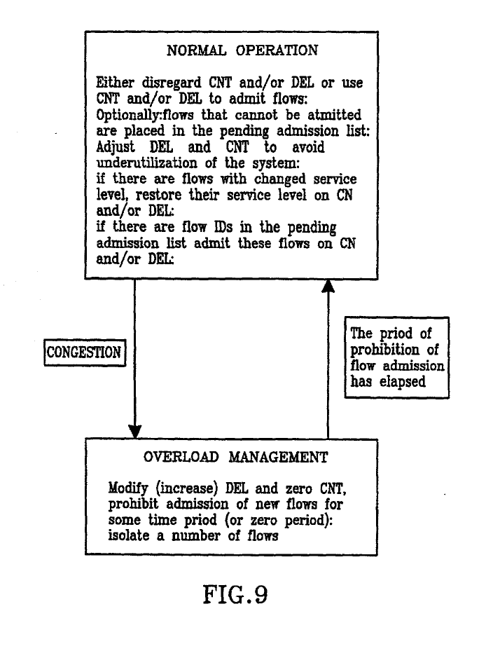

The invention may also be realized using a counter-based implementation (see FIG. 9). Contrary to the above arrangements, the congestion and/or congestion anticipation is defined as zero value of counter (CNT) with the value of the counter updated according to the following scheme, conditioned that there has been a violation of the Performance Parameter Targets (PPTs):

1. the counter is zeroed when the PPTs are violated;

2. the counter is incremented when a predetermined time period DELay (DEL) has elapsed since the last increment or zeroing as according to the previous step;

3. the counter is reduced when a new flow arrives or service level of a service-level-changed flow is restored and the counter is non-zero.

Value of variable DEL is updated according to the following scheme:

1. value of DEL is increased when the PPTs are violated;

2. if after step 1 PPTs are not violated value of DEL is reduced;

3. in step 1 the value of DEL is saved before it is increased in another variable MIN₁₃DEL, which is used as the lowest margin for reducing value of DEL in step 2.

It is also possible to use the delay without the counter. In this case the congestion and/or congestion anticipation is defined by value of timer T such that T<DEL or T<DEL conditioned there has been a violation of the PPTs. Value of the timer is updated according to the following scheme:

1. the timer is zeroed when the PPTs are violated;

2. the timer is zeroed when its value is such that T>DEL or T₁₃ DEL and a new flow arrives; the value of DEL is updated as before.

In one embodiment the real flow termination rate is used. A system according to the previous claims where the congestion and/or congestion anticipation is defined as zero value of counter CNT conditioned there has been a violation of the PPTs.

The value of CNT is defined in the following way:

1. If there have not been violations of PPTs (Performance Parameter Targets) value of CNT is disregarded, any flow is allowed on the link;

2. CNT is zeroed when there is a violation of PPTs;

3. CNT is incremented when a flow terminates on the link;

4. CNT is reduced if a new flow arrives on the link and CNT is non-zero.

Use of measured flow inter-termination delay.

In yet another embodiment, the congestion and/or congestion anticipation is defined as zero value of counter CNT conditioned that there has been a violation of the PPTs.

The value of the counter will be updated according to the following scheme:

1. the counter is zeroed when the Performance Parameter Targets (PPT) are violated;

2. the counter is incremented when DEL seconds have elapsed since the last increment or zeroing as according to the previous step;

3. the counter is reduced when a new flow arrives or a service-level-changed flow is gets its service level restored and the counter is non-zero.

Value of variable DEL is set to the measured flow inter-termination delay.

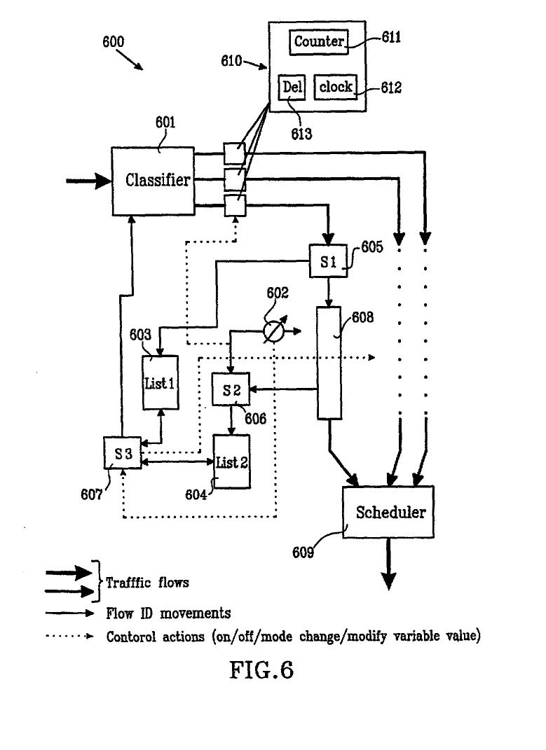

FIG. 6 shows an arrangement according to a second embodiment of the invention. According to this non-limiting embodiment, the arrangement 600, in the same way as the above illustrate arrangement 500, comprises a classifier arrangement 601, a load meter 602, first and second lists 603 and 604, first, second and third selectors 605-607, queue arrangements 608 and scheduler 609. The classifier arrangement 601 is provided for classifying packets to the priority/capacity queues/pipes, e.g., based on their header field values. The load meter 602 measures queue size and compares it against at least two thresholds (congestion or congestion anticipation and new flow admission) and also measures other performance parameters (e.g., delay and/or packet loss rate) and compares them with the respective performance parameter target values. The measurement is done using either some averaging process and/or the momentary values of the parameters. The lists and queue are realized as memory units. The scheduler 609 controls the different priority levels. Clearly, other parts needed for correct function of the arrangement can occur. The arrangement further comprises a clocking arrangement 610, comprising of a counter 611, a clock 612 and a memory 613.

The following example simplifies the understanding of the function of arrangement: in a first phase the selector S1 605 selects flow IDs from the queue and saves them in List 1 603; if there has been a congestion or congestion anticipation value of memory 613 is reduced after a predetermined time since the last modification of the memory 613.

In a second phase, the load meter 602 detects congestion or congestion anticipation and starts selector S2 606 and/or S3 607, if they have not been started; no new flows are allowed on the queue/pipe; value of the memory 613 is increased and the counter 611 is zeroed; selector 606 selects flow IDs from the queue 608 and saves them in List 2 604; the third selector 607 selects flow IDs from List 1 and List 2 and modifies service level of the respective flows by altering filtering criteria of the Classifier 601 so that the flows are moved away from the current queue; S3 can also be informed about the load of other queues before moving the flows to the said queues; S3 can contain flow IDs from previous congestion periods and can before taking flow IDs from List 1 and List 2 modify service level of the said previously selected flows.

In a third phase, after the queue load falls below the congestion/congestion anticipation level but not below the new flow admission level, the load meter stops third and/or second selectors.

In a fourth phase, the load meter detects load of the queue being under the new flow admission threshold and instructs the third selector to restore service level of the “service level modified flows” in an ordered or random way; when all the service level modified flows have obtained their service level modified admission of new flows on the queue is allowed.

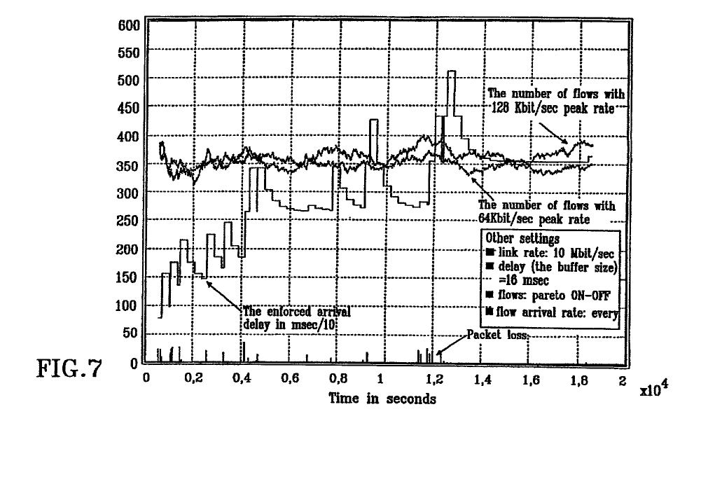

FIG. 7 illustrates result of a sample run of the method with two types of flows: 64 Kbit/sec and 128 Kbit/sec. Packet lost target was 1e⁻⁶ and the real packet loss was 3.447e⁻⁶. The arrivals of flows of every type were generated with equal probability.

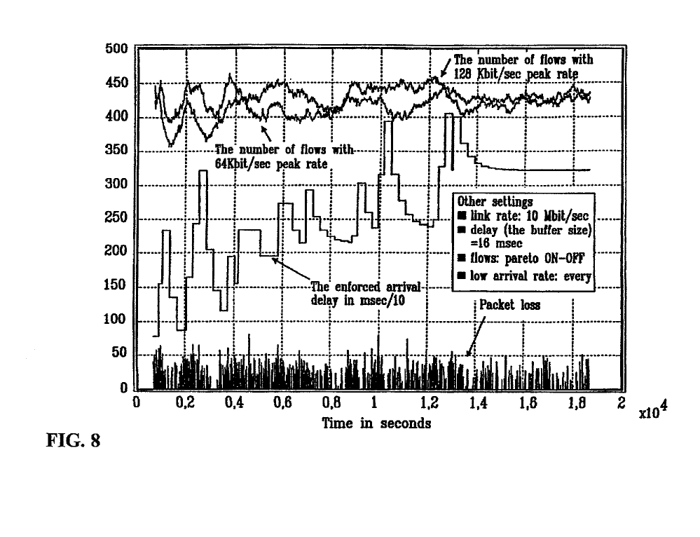

Also, FIG. 8 illustrates result of a sample run of the method with two types of flows: 64 Kbit/sec and 128 Kbit/sec. Packet lost target was 0.01 and the real packet loss was 0.0065. The arrivals of flows of every type were generated with equal probability.

The main parts of the invention can be realized as a computer program for any computer and can of course be distributed by means of any suitable medium.

The invention is not limited to the shown and described embodiments but can be varied in a number of ways without departing from the scope of the appended claims and the arrangement and the method can be implemented in various ways depending on application, functional units, needs and requirements etc.

1. A method for controlling congestion of a network node capacity shares used by a set of data flows, including non-terminated data flows having specific characteristics, in a communications network having links and nodes, the method of control comprising the steps of:
providing said network with different states of functionality, in a first state, when congestion or congestion anticipation in said specific characteristics mainly within a node of said network occurs, disabling admission of new data flows having said specific characteristics,
selecting a number of flows, and
changing a service level of the selected flows and/or an enforced average flow inter-arrival delay.

2. The method according to claim 1, further comprising the step of associating said capacity share with a packet servicing priority level and/or a packet flow aggregation criterion.

3. The method according to claim 1, wherein said specific characteristics comprise one or more of the same priority or service level being part of the same capacity share and flow aggregate.

4. The method according to claim 3, wherein said specific characteristics are not based on a time that the packets of the flows have spent in upstream nodes and/or on count of said upstream nodes the packets have passed through before the node that detects the said congestion.

5. The method according to claim 1, further comprising the step of selecting a number of flow identities from a first list (L1) either at random or of the most youngest flows whose specific characteristic including a service level is unchanged.

6. The method according to claim 1, further comprising the steps of selecting a number of data flows whose packets are in a queue while a link is congested, and saving their identities in a second list.

7. The method according to claim 6, wherein the selection is from head and/or tail and/or middle of the queue and/or through a selection principle.

8. The method according to claim 1, further comprising the step of changing first the specific characteristic that includes a service level of the youngest flows.

9. The method according to claim 1, further comprising the step of allowing new flows on the link in a second state in which there is no congestion.

10. The method according to claim 9, further comprising the step of remembering a number of most recent flows in the first list.

11. The method according to claim 9, further comprising the step of remembering a number of elected flows in said first list.

12. The method according to claim 9, further comprising the step of removing the identities of the data flows that have terminated from the lists.

13. The method according to claim 1, further comprising the step of not allowing new flows on the link in a third state, wherein in the third state the load of the specific characteristic including priority level is between the congestion or congestion anticipation threshold and the new flow admission threshold, when those new flows are with the priority level.

14. The method according to claim 1, further comprising the step of, in a fourth state wherein in the fourth state the load drops below the new flow admission threshold, either selecting from a first list a number of flow identities of the flows whose specific characteristic includes a service level has been changed and/or selecting from a second list a number of flow identities and restoring their service level.

15. The method according to claim 14, further comprising the step of making the selection at random and/or in an order and/or with respect to the oldest flows.

16. The method according to claim 14, further comprising the step of not allowing new flows on the link while there are flows with changed service level in the first list and/or the second list.

17. The method according to claim 1, wherein a transition condition from the second state to the first state exists if the load reaches and/or exceeds the congestion or congestion anticipation threshold.

18. The method according to claim 9, wherein a transition condition fro the first state to the third state exists if the load drops below the congestion or congestion anticipation threshold but stays above the new flow admission threshold.

19. The method according to claim 9, wherein a transition condition from the third state to the first state exists if the load reaches and/or exceeds the congestion or congestion anticipation threshold.

20. The method according to claim 9, wherein a transition condition from the third state to the second state exists if the load drops below the new flow admission threshold and there are no non-terminated flows with service level changed from the service level.

21. The method according to claim 13, wherein a transition condition from the third state to the fourth state exists if the load drops below the new flow admission threshold and there are non-terminated flows with changed service level.

22. The method according to claim 1, wherein a transition condition from the third state to the first state exists if the load reaches and/or exceeds the congestion or congestion anticipation threshold.

23. The method according to claim 1, further comprising the step of measuring said load by length of the queue and/or packet loss rate and/or the number of established flows.

24. The method according to claim 9, wherein a transition condition from the third state to the second state exists if there are no flows with changed service level.

25. The method according to claim 1, wherein said network is a differential service (DS) network..

26. The method according to claim 1, further comprising the step of increasing the enforced average flow inter-arrival delay.

27. The method according to claim 26, further comprising the step of increasing the enforced average flow inter-arrival delay by using a real flow inter-termination rate, the inter-termination rate being a reciprocal of the respective delay or the estimated optimal flow inter-arrival rate and selecting a number of flows and changing the service level of the selected flows.

28. The method according to claim 26, wherein the congestion and/or congestion anticipation is defined as zero value of a counter (CNT) with the value of the counter updated according to a scheme, conditioned that there has been a violation of Performance Parameter Targets (PPTs), the scheme comprising the steps of:
setting the value of said counter to zero when the PPTs are violated;
incrementing the counter when a predetermined time period Delay (DEL) has elapsed since the last increment or zeroing as according to the previous step; and
reducing the counter when a new flow arrives or service level of a service-level-changed flow is restored and the counter is non-zero.

29. The method according to claim 28, further comprising the steps of updating the value of variable DEL according to the following steps:
increasing the value of DEL when the PPTs are violated;
if after setting the value of said counter to zero when the PPTs are violated, PPTs are not violated, reducing the value of DEL;
in setting the value of said counter to zero when the PPTs are violated, saving the value of DEL before it is increased in a second variable (MIN₁₃DEL), which is used as the lowest margin for reducing value of DEL in step 2.

30. The method according to claim 26, further comprising the step of defining the congestion and/or congestion anticipation by value of a timer (T) such that T<DEL or T<DEL, where DEL is delay variable, conditioned on there having been a violation of the PPTs, wherein the value of a timer is updated according to the following steps:
zeroing the timer when the PPTs are violated;
zeroing the timer is zeroed when its value is such that T>DEL or T>DEL and a new flow arrives; updating the value of DEL as before.

31. The method according to claim 26, further comprising the step of defining the congestion and/or congestion anticipation as zero value of counter (CNT) conditioned on there having been a violation of PPTs, whereby a value of CNT is defined as follows:
allowing any flow on the link if there have not been violations of PPTs (Performance Parameter Targets) value of CNT is disregarded, any flow is allowed on the link,
zeroing CNT when there is a violation of PPTs,
incrementing CNT when a flow terminates on the link, and
reducing CNT if a new flow arrives on the link and CNT is non-zero.

32. The method according to claim 31, storing the flow ID in a list of admission pending flows when new flow arrives and when said counter is zero.

33. The method according to claim 26, further comprising the step of defining the congestion and/or congestion anticipation as zero value of a counter (CNT) conditioned that there has been a violation of the PPTs, and updating the value of the counter according to the following scheme:
zeroing the counter when the Performance Parameter Targets (PPT) are violated;
incrementing the counter when DEL seconds have elapsed since the last increment or zeroing as according to the previous step;
reducing the counter when a new flow arrives or a service-level-changed flow is gets its service level restored and the counter is non-zero, and
setting the value of variable DEL to the measured flow inter-termination delay.

34. An arrangement for controlling congestion of a network node capacity shares used by a set of data flows in a communications network, the arrangement comprising:
a classifier arrangement, a load meter, first and second lists, first, second and third selectors, a queue arrangement and scheduler, wherein said data flows include non-terminated data flows having specific characteristics.

35. The arrangement according to claim 34, wherein the classifier arrangement is provided for classifying packets to the priority/capacity queues/pipes.

36. The arrangement according to claim 34, wherein the load meter is arranged to measure the load in terms of queue size and/or packet loss rate and/or the number of established flows and compares it against at least the thresholds of congestion or congestion anticipation and new flow admission.

37. The arrangement according to claim 34, wherein, in a first phase, the first selector selects flow identities from the queue and saves them in the first list, in a second phase, the load meter detects congestion or congestion anticipation and starts the second and/or third selectors if they have not been started, no new flows are allowed on the queue/pipe, said second selector selects flow identities from the queue and saves them in a second list, said third selector selects flow identities from the lists and modifies said specific characteristic in form of service level of the respective flows, such that the flows are removed from the current priority level/pipe,
in a third phase, after the queue load falls below a congestion/congestion anticipation level but not below a new flow admission level the load meter stops first and/or second selectors, and
in a fourth phase, the load meter detects load of the queue being under the new flow admission threshold and instructs said third to restore service level of the service level modified flows in an ordered or random way.

38. The arrangement according to claim 34, wherein when all the service level modified flows have obtained their service level restored, admission of new flows on the queue is allowed.

39. The arrangement according to claim 34, wherein said modified service level of the respective flows is through altering classification criteria of the classifier arrangement.

40. The arrangement according to claim 34, wherein said third selector senses load of other priority levels/capacity pipes before moving the flows to the said levels/pipes.

41. The arrangement according to claim 34, wherein said third selector further comprises flow identities from previous congestion periods and, before taking flow identities from the first list and second list, modifies service level of said previously selected flows.

42. The arrangement according to claim 34, wherein said third selector is configured to modify service level of said previously selected flows.

43. The arrangement according to claim 34, wherein the congestion threshold is equal to the new flow admission threshold.

44. A medium readable by means of a computer and having a computer readable program code embodied therein, comprising:
said computer at least partly being an arrangement for controlling congestion of a network node capacity shares used by a set of data flows in a communications network,
said data flows including non-terminated data flows having specific characteristics,
said arrangement further comprising a classifier arrangement, a load meter, first and second lists, first, second and third selectors, a queue arrangement and a scheduler,
wherein said program code is provided for causing said arrangement to assume:
a first phase in which the first selector selects flow identities from the queue and saves them in the first list,
a second phase, in which the load meter detects congestion or congestion anticipation and starts the second and/or third selectors if they have not been started, no new flows are and saves them in a second list, said third selector selects flow identities from the lists and modifies said specific characteristic in form of service level of the respective flows, such that the flows are removed from the current priority level/pipe,
a third phase, in which after the queue load falls below a congestion/congestion anticipation level but not below a new flow admission level the load meter stops first and/or second selectors, and
a fourth phase, in which the load meter detects load of the queue being under the new flow admission threshold and instructs said third to restore service level of the service level modified flows in an ordered or random way.

45. A computer data signal embodied in a carrier wave, said computer signal comprising:
a computer readable program code readable by means of a computer, the computer at least partly being realized as an arrangement for controlling congestion of a network node capacity shares used by a set of data flows in a communications network, said data flows including non-terminated data flows having specific characteristics,
said arrangement mainly comprising a classifier arrangement, a load meter, first and second lists, first, second and third selectors, a queue arrangement and a scheduler,
wherein said program code is configured to cause said arrangement to assume:
a first phase in which the first selector selects flow identities from the queue and saves them in the first list,
a second phase, in which the load meter detects congestion or congestion anticipation and starts the second and/or third selectors if they have not been started, no new flows are allowed on the queue/pipe, said second selector selects flow identities from the queue and saves them in a second list, said third selector selects flow identities from the lists and modifies said specific characteristic in form of service level of the respective flows, such that the flows are removed from the current priority level/pipe,
a third phase, in which after the queue load falls below a congestion/congestion anticipation level but not below a new flow admission level the load meter stops first and/or second selectors, and admission threshold and instructs said third to restore service level of the service level modified flows in an ordered or random way.

46. A computer network in which a method according to claim 1 is applied.

47. A computer network comprising an arrangement according to claim 34.
